(19) United States
(12) Patent Application Publication
(10) Pub. No.: US 2026/0330870 A1
(43) Pub. Date: Oct. 22, 2026

(54) ARTIFICIAL INTELLIGENCE DEVICE AND OPERATION METHOD THEREOF

(71) Applicant: LG ELECTRONICS INC., Seoul (KR)

(72) Inventors: Sungjin KIM, Seoul (KR); Jinyoung HUR, Seoul (KR); Younghyeog JEON, Seoul (KR); Joongrock KIM, Seoul (KR); Jeong HEO, Seoul (KR); Jaehoon LEE, Seoul (KR)

(73) Assignee: LG ELECTRONICS INC., Seoul (KR)

(21) Appl. No.: 19/122,672

(22) PCT Filed: Oct. 21, 2022
(86) PCT No.: PCT/KR2022/016193

§ 371 Date: Apr. 18, 2025

(51) Int. Cl. G06V 40/16; G06T 11/60; G06V 20/40; G10L 13/04

(52) U.S. Cl. CPC G06V 40/165; G06T 11/60; G06V 20/41; G10L 13/04

(57) ABSTRACT

Disclosed are an artificial intelligence device and an operation method thereof. The operation method of an artificial intelligence device according to at least one of various embodiments disclosed herein can comprise the steps of: detecting an event; extracting at least one piece of image data constituting the video data according to the event; extracting speech data corresponding to the image data and performing STT processing; synthesizing the STT-processed data and the image data into a single image; and outputting the synthesized image.

### TECHNICAL FIELD

The present disclosure relates to an artificial intelligence device that provides a photo-toon service for a predetermined unit of data in video data and its operation method.

### BACKGROUND

With the rapid development of digital technology, the demand and supply for video and multimedia have been rapidly increasing recently.

In addition, there are more cases where videos are watched or videos are provided as search results compared to the past.

However, compared to text, it is impossible to check the entire content of a video at once and the entire content can be understood only by playing it. However, since the time required to understand the content, i.e. the video playback time, is relatively longer than that of text, unnecessary information must be continuously consumed and it is not easy to quickly obtain the desired information. In addition, it is not easy to immediately search and move to the desired information within the video.

For this reason, a method of providing a video summary is being studied, but since only the video data itself is summarized and provided, there is a problem that it is not easy to accurately convey information or understand the content from it.

### DETAILED DESCRIPTION

### Technical Problem

The present disclosure aims to provide an artificial intelligence device that provides a photo-toon service based on speech recognition technology and an operating method thereof.

### Technical Solution

A method for operating an artificial intelligence device according to at least one embodiment of various embodiments of the present disclosure can include detecting an event; extracting at least one image data configuring of the video data according to the event; extracting speech data corresponding to the image data and processing the speech data as STT; synthesizing the STT-processed data and the image data into a single image; and outputting the synthesized image.

According to the method for operating an artificial intelligence device according to at least one embodiment of the various embodiments of the present disclosure, the event can include receiving a photo-toon service request signal.

According to the method for operating an artificial intelligence device according to at least one embodiment of the various embodiments of the present disclosure, the at least one image data can be data corresponding to one of a frame, a scene, and a sequence unit that is a set of multiple scenes.

According to the method for operating an artificial intelligence device according to at least one embodiment of the various embodiments of the present disclosure, the at least one image data can be determined based on an object in the video data.

According to the method for operating an artificial intelligence device according to at least one embodiment of the various embodiments of the present disclosure, the method can further include detecting a face from the at least one image data; recognizing a face direction when a size of the detected face exceeds a threshold value; recognizing a mouth position of the face; determining a position of a speech bubble including the STT-processed data according to the face direction and the mouth position of the face recognized for the detected face; and synthesizing the speech bubble including the STT-processed data with the image data to be positioned at the determined position of the speech bubble.

According to the method for operating an artificial intelligence device according to at least one embodiment of the various embodiments of the present disclosure, the method can further include when a face is not detected from the at least one image data, determining a position of the speech bubble to be output to an area of the screen and synthesizing the speech bubble with the image data.

According to the method for operating an artificial intelligence device according to at least one embodiment of the various embodiments of the present disclosure, at least one image data can correspond to a scene change section in the video or a speech output section.

According to the method for operating an artificial intelligence device according to at least one embodiment of the various embodiments disclosure, when the synthesized images are multiple for the video data, the multiple synthesized images can be grouped and summarized according to predefined criteria, and only some of the synthesized images can be output.

An artificial intelligence device according to at least one embodiment of the various embodiments of the present disclosure can include a display configured to output video data; and a processor configured to control the display, wherein the processor is configured to detect an event, extract at least one image data configuring of the video data according to the event, extract speech data corresponding to the image data, process the speech data as STT, and synthesize the STT-processed data and the image data into a single image and output the synthesized image.

According to the artificial intelligence device according to at least one embodiment of the various embodiments of the present disclosure, the event can include receiving a photo-toon service request signal, and the at least one image data can be data corresponding to one of a frame, a scene, and a sequence unit that is a set of multiple scenes.

According to the artificial intelligence device according to at least one embodiment of the various embodiments of the present disclosure, the processor can be configured to determine the at least one image data based on an object in the video data.

According to the artificial intelligence device according to at least one embodiment of the various embodiments of the present disclosure, the processor can be configured to detect a face from the at least one image data, recognize, when a size of the detected face exceeds a threshold value, a face direction and a mouth position of the face, determine a position of a speech bubble including the STT-processed data according to the face direction and the mouth position of the face recognized for the detected face, and synthesize the speech bubble including the STT-processed data with the image data to be positioned at the determined position of the speech bubble.

According to the artificial intelligence device according to at least one embodiment of the various embodiments of the present disclosure, when a face is not detected from the at least one image data, the processor can be configured to determine a position of the speech bubble to be output to an area of the screen, and synthesize the speech bubble with the image data.

According to the artificial intelligence device according to at least one embodiment of the various embodiments of the present disclosure, at least one image data can correspond to a scene change section in the video or a speech output section.

According to the artificial intelligence device according to at least one embodiment of the various embodiments of the present disclosure, when the synthesized images are multiple for for the video data, the processor can be configured to group and summarize the multiple synthesized images according to a predefined criterion for the video data, and output only some of the synthesized images.

Additional scope of applicability of the present invention will become apparent from the detailed description below. However, since various changes and modifications within the scope of the present invention can be clearly understood by those skilled in the art, it should be understood that the detailed description and specific embodiments such as preferred embodiments of the present invention are given by way of example only.

### Effects of the Invention

According to at least one embodiment of the various embodiments of the present disclosure, there is an effect of providing a photo-toon service for a desired portion (all or part) of video data, thereby increasing the usability of the artificial intelligence device and increasing the user satisfaction.

According to at least one embodiment of the various embodiments of the present disclosure, there is an effect of providing a multimedia function in conjunction with various applications.

### BRIEF DESCRIPTION OF DRAWINGS

FIG. 1 is a drawing for explaining a speech system according to an embodiment of the present invention.

FIG. 2 is a block diagram for explaining the configuration of an artificial intelligence device according to an embodiment of the present disclosure.

FIG. 3 is a block diagram for explaining the configuration of a speech service server according to an embodiment of the present invention.

FIG. 4 is a drawing for explaining an example of converting a speech signal into a power spectrum according to an embodiment of the present invention.

FIG. 5 is a block diagram for explaining the configuration of a processor for speech recognition and synthesis of an artificial intelligence device according to an embodiment of the present invention.

FIG. 6 is a block diagram of a speech service system for providing a speech recognition-based photo-toon service according to an embodiment of the present disclosure.

FIG. 7 is a block diagram of a processor of FIG. 6.

FIGS. 8 to 11 are flowcharts illustrating a method for providing a photo-toon service according to an embodiment of the present disclosure.

FIGS. 12 to 14 are diagrams illustrating a method for providing a photo-toon service according to an embodiment of the present disclosure.

FIG. 15 is a diagram illustrating a method for providing a photo-toon service using speech recognition technology according to an embodiment of the present disclosure.

FIGS. 16a and 16b are diagrams illustrating a method for providing a photo-toon service using speech recognition technology according to an embodiment of the present disclosure.

### BEST MODE

Hereinafter, the embodiments disclosed in this specification will be described in detail with reference to the attached drawings. Regardless of the drawing symbols, identical or similar components will be given the same reference numbers and redundant descriptions thereof will be omitted. The suffixes “module” and “part” used for components in the following description are given or used interchangeably only for the convenience of writing the specification, and do not have distinct meanings or roles in themselves. In addition, when describing the embodiments disclosed in this specification, it is determined that a specific description of a related known technology can obscure the gist of the embodiments disclosed in this specification, the detailed description thereof will be omitted. In addition, the attached drawings are only intended to facilitate easy understanding of the embodiments disclosed in this specification, and the technical ideas disclosed in this specification are not limited by the attached drawings, and should be understood to include all modifications, equivalents, and substitutes included in the technical scope of the present invention.

Terms including ordinal numbers such as first, second, etc. can be used to describe various components, but the components are not limited by the terms. The terms are used only for the purpose of distinguishing one component from another.

When a component is referred to as being “connected” or “connected” to another component, it should be understood that it can be directly connected or connected to that other component, but that there can be other components in between. On the other hand, when a component is referred to as being “directly connected”or “directly connected” to another component, it should be understood that there are no other components in between.

The ‘AI device’ described in this specification can include a mobile phone, a smart phone, a laptop computer, an AI device for digital broadcasting, a personal digital assistant (PDA), a portable multimedia player (PMP), a navigation device, a slate PC, a tablet PC, an ultrabook, a wearable device (e.g., a smartwatch, a smart glass, a head mounted display (HMD) ), etc.

However, the AI device according to the embodiment described in this specification can also be applied to fixed AI devices such as a smart TV, a desktop computer, a digital signage, a refrigerator, a washing machine, an air conditioner, a dishwasher, etc.

In addition, the AI device 10 according to the embodiment of the present invention can also be applied to a fixed or movable robot.

In addition, the AI device 10 according to the embodiment of the present invention can perform the function of a speech agent. A speech agent can be a program that recognizes a user's speech and outputs a response appropriate to the recognized user's speech as a voice.

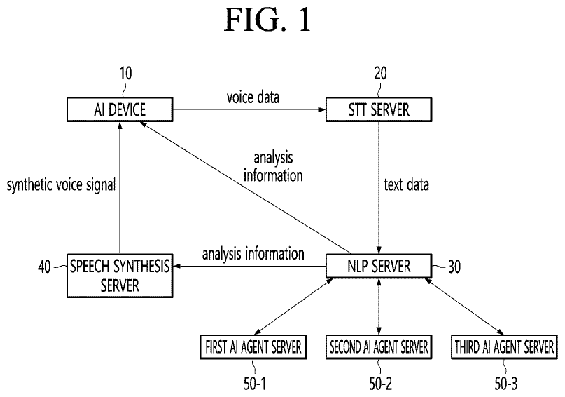

FIG. 1 is a diagram for explaining a speech service system 13 according to an embodiment of the present invention.

The speech service can include at least one of a speech recognition and a speech synthesis service. The speech recognition and synthesis process can include a process of converting a speaker's (or user's) speech data into text data, analyzing the speaker's intention based on the converted text data, converting text data corresponding to the analyzed intention into synthetic speech data, and outputting the converted synthetic speech data.

For the speech recognition and synthesis process, a speech service system, such as that illustrated in FIG. 1, can be used.

Referring to FIG. 1, the speech service system can include an artificial intelligence device 10, a speech-to-text (STT) server 20, a natural language processing (NLP) server 30, and a speech synthesis server 40. A plurality of AI agent servers 50-1 to 50-3 communicate with the NLP server 30 and can be included in the speech service system.

Meanwhile, the STT server 20, the NLP server 30, and the speech synthesis server 40 can exist as separate servers as illustrated, or can be included in one server. In addition, the plurality of AI agent servers 50-1 to 50-3 can also exist as separate servers or can be included in the NLP server 30.

The artificial intelligence device 10 can transmit a voice signal corresponding to the speaker's voice received through the microphone 122 to the STT server 20.

The STT server 20 can convert voice data received from the artificial intelligence device 10 into text data.

The STT server 20 can use a language model to increase the accuracy of speech-to-text conversion.

A language model can refer to a model that can calculate the probability of a sentence or calculate the probability of a next word given the previous words.

For example, a language model can include probabilistic language models such as a Unigram model, a Bigram model, an N-gram model, etc.

The Unigram model is a model that assumes that the inflection of all words is completely independent of each other, and calculates the probability of a word string as the product of the probabilities of each word.

The Bigram model is a model that assumes that the inflection of a word depends on only one previous word.

The N-gram model is a model that assumes that the inflection of a word depends on (n−1) previous words.

That is, the STT server 20 can use a language model to determine whether text data converted from voice data is properly converted, and thereby increase the accuracy of conversion to text data.

The NLP server 30 can receive text data from the STT server 20. The STT server 20 can also be included in the NLP server 30.

The NLP server 30 can perform intent analysis on the text data based on the received text data.

The NLP server 30 can transmit intent analysis information indicating the result of performing intent analysis to the artificial intelligence device 10.

The NLP server 30 can transmit intent analysis information to the speech synthesis server 40. The speech synthesis server 40 can generate a synthetic speech based on the intent analysis information and transmit the generated synthetic speech to the artificial intelligence device 10.

The NLP server 30 can sequentially perform a morphological analysis step, a syntactic analysis step, a speech act analysis step, and a dialogue processing step on the text data to generate intent analysis information.

The morphological analysis step is the step of classifying text data corresponding to the user's spoken voice into morpheme units, which are the smallest units that have meaning, and determining which part of speech each classified morpheme has.

The syntactic analysis step is the step of using the results of the morphological analysis step to classify text data into noun phrases, verb phrases, and adjective phrases, and determining what kind of relationship exists between each of the classified phrases.

Through the syntactic analysis step, the subject, object, and modifiers of the user's spoken voice can be determined.

The speech act analysis step is the step of analyzing the user's intention for the spoken voice using the results of the syntactic analysis step. Specifically, the speech act analysis step is the step of determining the intention of the sentence, such as whether the user is asking a question, making a request, or simply expressing emotions.

The dialogue processing step is a step that uses the results of the speech act analysis step to determine whether to answer, respond, or ask a question for additional information about the user's utterance.

After the dialogue processing step, the NLP server 30 can generate intent analysis information including at least one of an answer, response, or additional information inquiry for the user's utterance intention.

The NLP server 30 can transmit a search request to a search server (not shown) to search for information that matches the user's utterance intention, and can receive search information corresponding to the search request.

If the user's utterance intention is to search for content, the search information can include information about the searched content.

The NLP server 30 can transmit the search information to the artificial intelligence device 10, and the artificial intelligence device 10 can output the search information.

Meanwhile, the NLP server 30 can also receive text data from the artificial intelligence device 10. For example, if the AI device 10 supports a speech-to-text conversion function, the AI device 10 can convert speech data into text data and transmit the converted text data to the NLP server 30.

The speech synthesis server 40 can generate a synthetic speech by combining previously stored speech data.

The speech synthesis server 40 can record the speech of a person selected as a model and divide the recorded speech into syllables or words.

The speech synthesis server 40 can store the divided speech into syllables or words in an internal or external database.

The speech synthesis server 40 can search for syllables or words corresponding to given text data from the database and synthesize a combination of the searched syllables or words to generate a synthetic speech.

The speech synthesis server 40 can store a plurality of speech language groups corresponding to each of a plurality of languages.

For example, the speech synthesis server 40 can include a first speech language group recorded in Korean and a second speech language group recorded in English.

The speech synthesis server 40 can translate text data of the first language into text of the second language, and can generate a synthetic speech corresponding to the translated text of the second language using the second speech language group.

The speech synthesis server 40 can transmit the generated synthetic speech to the artificial intelligence device 10.

The speech synthesis server 40 can receive analysis information from the NLP server 30. The analysis information can include information analyzing the intent of the speech spoken by the user.

The speech synthesis server 40 can generate a synthetic speech reflecting the intent of the user based on the analysis information.

The functions of the STT server 20, the NLP server 30, and the speech synthesis server 40 described above can also be performed by the artificial intelligence device 10. For this purpose, the artificial intelligence device 10 can include one or more processors.

Each of the plurality of AI agent servers 50-1 to 50-3 can transmit search information to the NLP server 30 or the artificial intelligence device 10 according to the request of the NLP server 30.

If the intent analysis result of the NLP server 30 is a content search request, the NLP server 30 can transmit the content search request to one or more of the plurality of AI agent servers 50-1 to 50-3 and receive the content search result from the server.

The NLP server 30 can transmit the received search result to the artificial intelligence device 10.

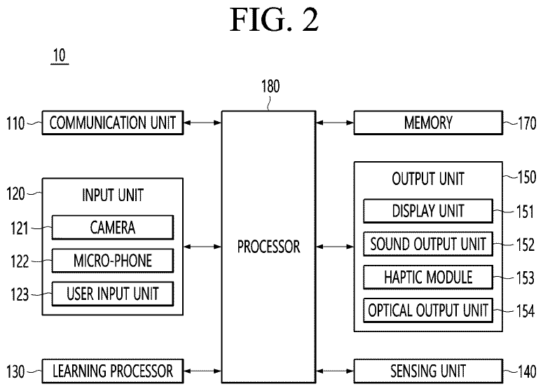

FIG. 2 is a block diagram for explaining the configuration of an artificial intelligence device 10 according to an embodiment of the present disclosure.

Referring to FIG. 2, the artificial intelligence device 10 can include a communication unit 110, an input unit 120, a learning processor 130, a sensing unit 140, an output unit 150, a memory 170, and a processor 180.

The communication unit 110 can transmit and receive data with external devices using wired and wireless communication technology. For example, the communication unit 110 can transmit and receive sensor information, user input, learning models, control signals, etc. with external devices.

At this time, the communication technologies used by the communication unit 110 include GSM (Global System for Mobile communication), CDMA (Code Division Multi Access), LTE (Long Term Evolution), LTV-A (advanced), 5G, WLAN (Wireless LAN), Wi-Fi (Wireless-Fidelity), Bluetooth (Bluetooth™), RFID (Radio Frequency Identification), Infrared Data Association (IrDA), ZigBee, NFC (Near Field Communication), etc.

The input unit 120 can obtain various types of data.

The input unit 120 can include a camera for inputting a video signal, a microphone for receiving an audio signal, a user input unit for receiving information from a user, etc. Here, the camera or microphone can be treated as a sensor, and the signal obtained from the camera or microphone can be referred to as sensing data or sensor information.

The input unit 120 can obtain input data to be used when obtaining output using learning data and learning models for model learning. The input unit 120 can also obtain unprocessed input data, in which case the processor 180 or learning processor 130 can extract input features as preprocessing for the input data.

The input unit 120 can include a camera (Camera, 121) for inputting image signals, a microphone (Microphone, 122) for receiving audio signals, and a user input unit (User Input Unit, for receiving information from a user.

Speech data or image data collected by the input unit 120 can be analyzed and processed as a user's control command.

The input unit 120 is for inputting image information (or signal), audio information (or signal), data, or information input from a user. For inputting image information, the AI device 10 can be equipped with one or more cameras 121.

The camera 121 processes image frames such as still images or moving images obtained by an image sensor in a video call mode or a shooting mode. The processed image frames can be displayed on the display unit 151 or stored in the memory 170.

The microphone 122 processes an external sound signal into electrical speech data. The processed speech data can be utilized in various ways depending on the function being performed (or the application being executed) in the AI device 10. Meanwhile, various noise removal algorithms can be applied to the microphone 122 to remove noise generated in the process of receiving an external sound signal.

The user input unit 123 is for receiving information from the user, and when information is input through the user input unit 123, the processor 180 can control the operation of the artificial intelligence device 10 to correspond to the input information.

The user input unit 123 can include a mechanical input means (or a mechanical key, for example, a button located on the front/rear or side of the terminal 100, a dome switch, a jog wheel, a jog switch, etc.) and a touch input means. As an example, the touch input means can be composed of a virtual key, a soft key, or a visual key displayed on a touch screen through software processing, or a touch key placed on a part other than the touch screen.

The learning processor 130 can train a model composed of an artificial neural network using learning data. Here, the learned artificial neural network can be called a learning model. The learning model can be used to infer a result value for new input data that is not learning data, and the inferred value can be used as a basis for judgment to perform a certain action.

The learning processor 130 can include a memory integrated or implemented in the artificial intelligence device 10. Alternatively, the learning processor 130 can be implemented using a memory 170, an external memory directly coupled to the artificial intelligence device 10, or a memory maintained in an external device.

The sensing unit 140 can obtain at least one of the internal information of the artificial intelligence device 10, the surrounding environment information of the artificial intelligence device 10, and the user information using various sensors.

At this time, the sensors included in the sensing unit 140 include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, a light sensor, a microphone, a lidar, a radar, etc.

The output unit 150 can generate output related to visual, auditory, or tactile sensations.

The output unit 150 can include at least one of a display unit 151, a sound output unit 152, a haptic module 153, and an optical output unit 154.

The display unit 151 displays (outputs) information processed in the artificial intelligence device 10. For example, the display unit 151 can display execution screen information of an application program driven by the artificial intelligence device 10, or User Interface (UI) or Graphical User Interface (GUI) information according to such execution screen information.

The display unit 151 can implement a touch screen by forming a mutual layer structure with a touch sensor or forming an integral structure. This touch screen can function as a user input unit 123 that provides an input interface between an artificial intelligence device 10 and a user, and at the same time, can provide an output interface between a terminal 100 and a user.

The audio output unit 152 can output audio data received from a communication unit 110 or stored in a memory 170 in a call signal reception mode, a call mode or a recording mode, a speech recognition mode, a broadcast reception mode, etc.

The audio output unit 152 can include at least one of a receiver, a speaker, a buzzer, etc.

The haptic module 153 generates various tactile effects that a user can feel. A representative example of the tactile effect generated by the haptic module 153 can be vibration.

The light output unit 154 outputs a signal to notify the occurrence of an event using the light of the light source of the artificial intelligence device 10. Examples of events occurring in the artificial intelligence device 10 can include message reception, call signal reception, missed call, alarm, schedule notification, email reception, information reception through an application, etc.

The memory 170 can store data supporting various functions of the artificial intelligence device 10. For example, the memory 170 can store input data, learning data, learning models, learning history, etc. obtained from the input unit 120.

The processor 180 can determine at least one executable operation of the artificial intelligence device 10 based on information determined or generated using a data analysis algorithm or a machine learning algorithm. In addition, the processor 180 can control components of the artificial intelligence device 10 to perform the determined operation.

The processor 180 can request, search, receive, or utilize data from the running processor 130 or the memory 170, and control components of the artificial intelligence device 10 to execute at least one of the executable operations, a predicted operation, or an operation determined to be desirable.

If the processor 180 requires connection to an external device to perform the determined operation, the processor 180 can generate a control signal for controlling the external device and transmit the generated control signal to the external device.

The processor 180 can obtain intent information for the user input, and determine the user's requirement based on the obtained intent information.

The processor 180 can obtain intent information corresponding to the user input by using at least one of an STT engine for converting a speech input into a string or an NLP engine for obtaining intent information of a natural language.

At least one of the STT engine or the NLP engine can be configured with an artificial neural network at least partially learned according to a machine learning algorithm. And, at least one of the STT engine or the NLP engine can be learned by the learning processor 130, learned by the learning processor 240 of the AI server 200, or learned by distributed processing of these.

The processor 180 can collect history information including the operation contents of the artificial intelligence device 10 or the user's feedback on the operation, and store it in the memory 170 or the learning processor 130, or transmit it to an external device such as the AI server 200. The collected history information can be used to update the learning model.

The processor 180 can control at least some of the components of the artificial intelligence device 10 to drive the application program stored in the memory 170. Furthermore, the processor 180 can operate two or more of the components included in the artificial intelligence device 10 in combination to drive the application program.

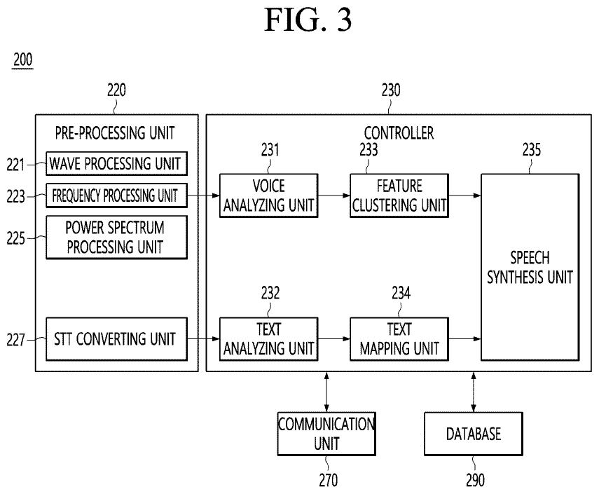

FIG. 3 is a block diagram for explaining the configuration of a speech service server 200 according to an embodiment of the present invention.

The speech service server 200 can include one or more of the STT server 20, the NLP server 30, and the speech synthesis server 40 illustrated in FIG. 1. The speech service server 200 can be referred to as a server system.

Referring to FIG. 3, the speech service server 200 can include a preprocessing unit 220, a controller 230, a communication unit 270, and a database 290.

The preprocessing unit 220 can preprocess speech received through the communication unit 270 or speech stored in the database 290.

The preprocessing unit 220 can be implemented as a separate chip from the controller 230 or implemented as a chip included in the controller 230.

The preprocessing unit 220 can receive a speech signal (spoken by a user) and filter out noise signals from the speech signal before converting the received speech signal into text data.

If the preprocessing unit 220 is equipped in the artificial intelligence device 10, it can recognize a trigger word for activating speech recognition of the artificial intelligence device 10. The preprocessing unit 220 can convert the trigger word received through the microphone 121 into text data, and if the converted text data corresponds to a previously stored trigger word, it can be determined that the trigger word has been recognized.

The preprocessing unit 220 can convert the noise-removed speech signal into a power spectrum.

The power spectrum can be a parameter that indicates which frequency components are included in the waveform of a speech signal that varies over time and at what size.

The power spectrum shows the distribution of the squared amplitude values according to the frequency of the waveform of the speech signal.

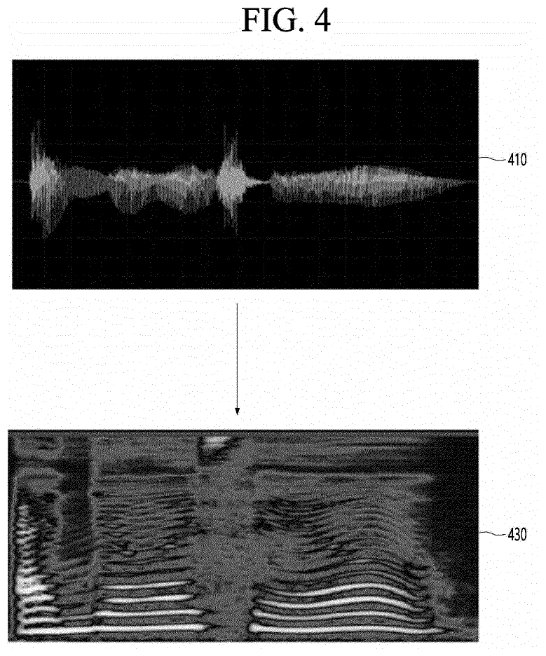

This will be explained with reference to FIG. 4.

FIG. 4 is a diagram illustrating an example of converting a speech signal into a power spectrum according to an embodiment of the present invention.

Referring to FIG. 4, a speech signal 410 is illustrated. The speech signal 410 can be received from an external device or can be a signal previously stored in a memory 170.

The x-axis of the speech signal 310 can represent time, and the y-axis can represent the amplitude.

The power spectrum processing unit 225 can convert the speech signal 410 whose x-axis is the time axis into a power spectrum 430 whose x-axis is the frequency axis.

The power spectrum processing unit 225 can convert the speech signal 410 into a power spectrum 430 using a Fast Fourier transform (FFT).

The x-axis of the power spectrum 430 represents frequency, and the y-axis represents the square value of the amplitude.

FIG. 3 is described again.

The functions of the preprocessing unit 220 and the controller 230 described in FIG. 3 can also be performed in the NLP server 30.

The preprocessing unit 220 can include a wave processing unit 221, a frequency processing unit 223, a power spectrum processing unit 225, and an STT conversion unit 227.

The wave processing unit 221 can extract a waveform of a speech.

The frequency processing unit 223 can extract a frequency band of a speech.

The power spectrum processing unit 225 can extract a power spectrum of a speech.

The power spectrum can be a parameter indicating which frequency components are included in a given waveform that varies in time and at what size.

The STT conversion unit 227 can convert speech into text.

The STT conversion unit 227 can convert speech in a specific language into text in the corresponding language.

The controller 230 can control the overall operation of the speech service server 200.

The controller 230 can include a voice analysis unit 231, a text analysis unit 232, a feature clustering unit 233, a text mapping unit 234, and a speech synthesis unit 235.

The voice analysis unit 231 can extract characteristic information of speech by using one or more of the speech waveform, speech frequency band, and speech power spectrum preprocessed in the preprocessing unit 220.

The characteristic information of the speech can include one or more of the speaker's gender information, the speaker's speech (or tone), pitch, the speaker's speech style, the speaker's speaking speed, and the speaker's emotion.

In addition, the characteristic information of the speech can further include the speaker's tone.

The text analysis unit 232 can extract key expression phrases from the text converted by the speech-to-text conversion unit 227.

If the text analysis unit 232 detects a difference in tone between phrases in the converted text, it can extract the phrase with the different tone as the key expression phrase.

If the frequency band between phrases changes by more than a preset band, the text analysis unit 232 can determine that the tone has changed.

The text analysis unit 232 can also extract key words from the phrases of the converted text. The main word can be a noun within a phrase, but this is only an example.

The feature clustering unit 233 can classify the speaker's speech type by using the characteristic information of the speech extracted from the voice analysis unit 231.

The feature clustering unit 233 can classify the speaker's speech type by assigning weights to each of the type items constituting the characteristic information of the speech.

The feature clustering unit 233 can classify the speaker's speech type by using the attention technique of the deep learning model.

The text mapping unit 234 can translate the text converted into the first language into the text of the second language.

The text mapping unit 234 can map the text translated into the second language with the text of the first language.

The text mapping unit 234 can map the main expression phrases that constitute the text of the first language to the corresponding phrases of the second language.

The text mapping unit 234 can map the speech types corresponding to the main expression phrases that constitute the text of the first language to the phrases of the second language. This is to apply the classified speech types to the phrases of the second language.

The speech synthesis unit 235 can apply the speech types and the speaker's tone classified by the feature clustering unit 233 to the main expression phrases of the text translated into the second language by the text mapping unit 234, thereby generating a synthesized speech.

The controller 230 can determine the user's speech characteristics by using one or more of the transmitted text data or the power spectrum 430.

The user's speech characteristics can include the user's gender, the user's pitch, the user's tone, the user's speech topic, the user's speech speed, the user's speech volume, etc.

The controller 230 can obtain the frequency of the speech signal 410 and the amplitude corresponding to the frequency using the power spectrum 430.

The controller 230 can determine the gender of the user who has spoken the speech using the frequency band of the power spectrum 430.

For example, the controller 230 can determine the user's gender as male if the frequency band of the power spectrum 430 is within a preset first frequency band range.

The controller 230 can determine the user's gender as female if the frequency band of the power spectrum 430 is within a preset second frequency band range. Here, the second frequency band range can be larger than the first frequency band range.

The controller 230 can determine the pitch of the speech using the frequency band of the power spectrum 430.

For example, the controller 230 can determine the pitch of the speech according to the amplitude size within a specific frequency band range.

The controller 230 can determine the user's tone using the frequency band of the power spectrum 430. For example, the controller 230 can determine a frequency band whose amplitude size is greater than a certain size among the frequency bands of the power spectrum 430 as the user's main tone range, and can determine the determined main tone range as the user's tone.

The controller 230 can determine the user's speech speed through the number of syllables spoken per unit time from the converted text data.

The controller 230 can determine the user's speech topic using the Bag-Of-Word Model technique for the converted text data.

The Bag-Of-Word Model technique is a technique that extracts frequently used words based on the word frequency in a sentence. Specifically, the Bag-Of-Word Model technique is a technique that extracts unique words from a sentence, expresses the frequency of each extracted word as a vector, and determines the utterance topic as a feature.

For example, if words such as <running>and <physical strength>frequently appear in the controller 230 text data, the user's utterance topic can be classified as exercise.

The controller 230 can determine the user's utterance topic from the text data using a known text categorization technique. The controller 230 can determine the user's utterance topic by extracting keywords from the text data.

The controller 230 can determine the user's speech volume by considering the amplitude information in the entire frequency band.

For example, the controller 230 can determine the user's speech volume based on the average or weighted average of the amplitude in each frequency band of the power spectrum.

The communication unit 270 can perform wired or wireless communication with an external server.

The database 290 can store a speech of a first language included in the content.

The database 290 can store a synthetic speech in which a speech of a first language is converted into a speech of a second language.

The database 290 can store a first text corresponding to a speech of a first language and a second text in which the first text is translated into a second language.

The database 290 can store various learning models required for speech recognition.

Meanwhile, the processor 180 of the artificial intelligence device 10 illustrated in FIG. 2 can be equipped with a preprocessing unit 220 and a controller 230 illustrated in FIG. 3.

That is, the processor 180 of the artificial intelligence device 10 can perform the functions of the preprocessing unit 220 and the controller 230.

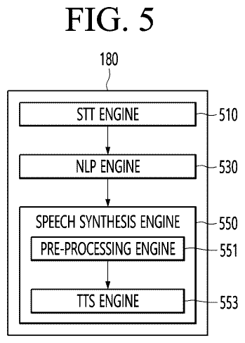

FIG. 5 is a block diagram illustrating the configuration of a processor for speech recognition and synthesis of an artificial intelligence device 10 according to an embodiment of the present invention.

That is, the speech recognition and synthesis process of FIG. 5 can be performed by a running processor 130 or processor 180 of an artificial intelligence device 10 without going through a server.

Referring to FIG. 5, the processor 180 of the artificial intelligence device 10 can include an STT engine 510, an NLP engine 530, and a speech synthesis engine 550.

Each engine can be either hardware or software.

The STT engine 510 can perform the function of the STT server 20 of FIG. 1. That is, the STT engine 510 can convert speech data into text data.

The NLP engine 530 can perform the function of the NLP server 30 of FIG. 1. That is, the NLP engine 530 can obtain intent analysis information indicating the speaker's intent from the converted text data.

The speech synthesis engine 550 can perform the function of the speech synthesis server 40 of FIG. 1.

The speech synthesis engine 550 can search for syllables or words corresponding to given text data from a database, and synthesize a combination of the searched syllables or words to generate a synthesized speech.

The speech synthesis engine 550 can include a preprocessing engine 551 and a TTS engine 553.

The preprocessing engine 551 can preprocess text data before generating a synthesized speech.

Specifically, the preprocessing engine 551 performs tokenization, which divides text data into tokens, which are meaningful units.

After tokenization, the preprocessing engine 551 can perform a cleansing operation to remove unnecessary characters and symbols to remove noise.

After that, the preprocessing engine 551 can integrate word tokens with different expression methods to generate the same word token.

After that, the preprocessing engine 551 can remove meaningless word tokens (stopwords).

The TTS engine 553 can synthesize speech corresponding to the preprocessed text data and generate a synthesized speech.

Hereinafter, various embodiments of providing a photo-toon service using speech service technology (e.g., speech recognition, speech synthesis, etc.) for video data of various lengths based on various platforms consumed by artificial intelligence devices are described.

The “photo-toon” described in the present disclosure is a compound word of photo and toon, and refers to a synthetic image (still image or video format) obtained by obtaining an image (still image or video format) for a desired portion (e.g., all or part) of video data provided through an artificial intelligence device 10, converting corresponding speech data into text, and then synthesizing the converted text with the obtained image. The process of generating and providing a photo-toon for video data in an artificial intelligence device 10 is referred to as a “photo-toon service.” However, the present disclosure is not limited to the above-mentioned term.

According to one embodiment of the present disclosure, the artificial intelligence device 10 can provide a summary service (summary or summary data) for a desired portion of target video data through the photo-toon service.

According to one embodiment, the photo-toon service can be provided in a form in which the target video data is output as is, but the synthesized photo-toon image is output only in a specific section, that is, the photo-toon service section.

According to another embodiment, the photo-toon service can be provided in a form in which the synthesized photo-toon image for a specific section is generated separately from the playback of the target video, and only the photo-toon service that outputs the corresponding synthesized photo-toon image is output.

Meanwhile, a plurality of photo-toon service sections or a plurality of synthesized photo-toon images can be generated and provided as a service for one target video.

The artificial intelligence device 10 can provide a service to the user so that the target video can be consumed by skipping the photo-toon service section unit at the user's request through an event detection, for example, a remote control device.

Alternatively, when the photo-toon service is activated or requested through event detection, the artificial intelligence device 10 can distinguish a section (area) in which the photo-toon service is available within the target video, and provide each distinguished photo-toon service section so that the user can identify and select it.

When there are multiple data configured as photo-toon services for the target video, the artificial intelligence device 10 can list and provide them so that they can be selected, and can output the selected photo-toon service data.

In the present disclosure, the photo-toon synthesis data can be generated in units of desired sections. Here, the term ‘desired section’ can refer to, for example, a frame, a scene, a sequence unit composed of multiple scenes, etc. For example, even when the photo-toon service is requested for a sequence unit, the artificial intelligence device 10 can generate photo-toon synthesis data only for some of the scenes (or main scenes) that constitute the sequence, not all the scenes that constitute the sequence. However, it is not necessarily limited to the above.

Hereinafter, in relation to the photo-toon service, an STT conversion technology based on speech recognition technology can be used.

The speech recognition technology can be processed by an STT engine (and NLP engine) equipped in the artificial intelligence device 10, but is not necessarily limited thereto. For example, the speech recognition technology can be processed by an STT server 20 and an NLP server 30 in the speech service server 200 and transmitted to the artificial intelligence device 10.

The artificial intelligence device 10 can provide a photo-toon service menu item by creating it on a dashboard or a menu of various artificial intelligence devices 10 so that the user can easily enter and use the photo-toon service, or can provide a photo-toon service-specific application so that the user can download and install it and use it. Alternatively, when an event request such as selection or playback of a video longer than a preset length is received, the artificial intelligence device 10 can provide a guide for using the photo-toon service, such as an icon or an OSD message (On Screen Display message).

The speech service server 200 can provide a photo-toon service platform and can support or guide the use of the photo-toon service for the target video data in the form of a web service or web app through the artificial intelligence device 10.

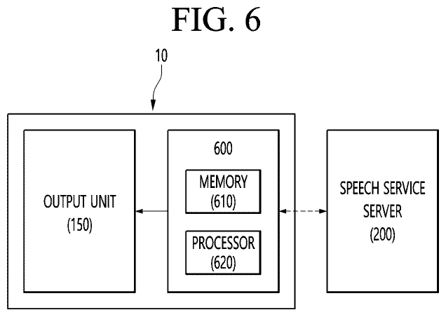

FIG. 6 is a block diagram of a speech service system for providing a speech recognition-based photo-toon service according to an embodiment of the present disclosure.

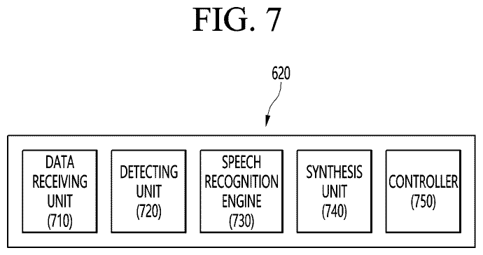

FIG. 7 is a block diagram of a processor 620 of FIG. 6.

First, referring to FIG. 6, the speech service system for providing a speech recognition-based photo-toon service can be configured to include an artificial intelligence device 10. According to an embodiment, the speech service server 200 can replace all or part of the functions related to the photo-toon service of the artificial intelligence device 10.

The artificial intelligence device 10 can include an output unit 150 and a processing unit 600 that output photo-toon service data and/or video data including photo-toon service data.

The processing unit 600 can be configured to include a memory (610) and a processor 620.

The processor 620 controls the overall function of the processing unit 600 and can perform operations for providing a photo-toon service.

Referring to FIG. 7, the processor 620 can be configured to include a data receiving unit 710, a detection unit 720, a speech recognition engine 730, a synthesis unit 740, and a control unit 750 for providing a photo-toon service. Here, at least one of the various components constituting the processor 620 can be implemented in the form of multiple modules, unlike as illustrated. According to an embodiment, the processor 620 can be configured to further include at least one component not illustrated in FIG. 7.

The data receiving unit 710 can receive video data, identify a photo-toon service request section (or a photo-toon service candidate section), and process the identified photo-toon service candidate section by dividing it into predetermined units. The predetermined units can be the aforementioned frame units, scene units, sequence units, etc. This division can be made only for the target video to which the photo-toon service is applied or the photo-toon service request section units of the target video.

The detection unit 720 can detect photo-toon service-related information for predetermined units in the target video data. The information detected in this way can include at least one of scene/sequence change information, main scene information, facial feature information, face-based representative scene information, speech information, etc.

The detection unit 720 can include a preprocessing module, a learning module, etc., and can automatically detect at least one of the aforementioned information by learning a generated artificial intelligence model related to the photo-toon service.

The speech recognition engine 730 can convert speech information corresponding to image information detected through the detection unit 720 into text information, including the STT engine. As described above, depending on the embodiment, the function of the speech recognition engine 730 can be performed by the STT server 20 in the speech recognition server 200, in which case the speech recognition engine 730 in FIG. 7 can be deactivated or excluded from the configuration.

The synthesis unit 740 can process and synthesize the image information detected by the detection unit 720 and the text information converted through the speech recognition engine 730 so that they are in sync with each other.

The control unit 750 can perform a role of controlling the overall operation and function of the processor 620.

The control unit 750 can control each of the above components to provide the photo-toon service according to the present disclosure for the target video.

Meanwhile, the processor 620 can have the same configuration as the processor 180 of FIG. 2, but can also have a separate configuration.

Although it is described as an artificial intelligence device 10 for convenience of explanation in the present disclosure, it can be replaced with a speech service server 200 or can include operating together depending on the context.

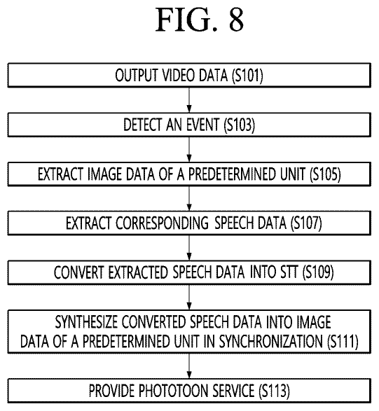

FIGS. 8 to 11 are flowcharts illustrating a method for providing a speech recognition-based photo-toon service according to an embodiment of the present disclosure.

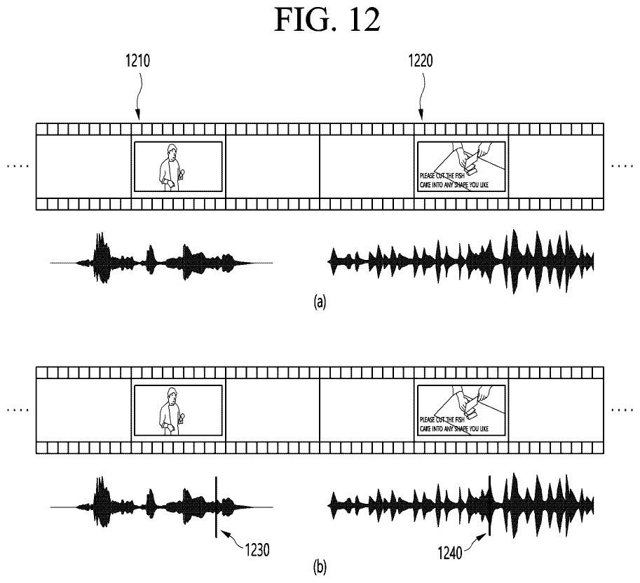

FIGS. 12 to 14 are diagrams illustrating a method for providing a photo-toon service according to an embodiment of the present disclosure.

FIG. 8 is described from the perspective of the processor 620 for convenience of explanation, but is not limited thereto.

Referring to FIG. 8, the processor 620 can output video data through the output unit 150 (S101).

The processor 620 can detect an event (S103).

The event can indicate various inputs, actions, etc. related to the photo-toon service. For example, the event can indicate the reception of a user's photo-toon service request signal through a remote control device (not shown). The remote control device can include a remote control, a mobile device such as a smartphone or tablet PC with an application for data communication installed with an artificial intelligence device 10, an artificial intelligence speaker, etc.

Such an event can occur during viewing of video data, such as in step S101, or cannot occur. In the latter case, as described above, the event can occur through a single menu item on the home menu or through speech input in an any screen state (e.g., a state where the video is not playing). In this sense, step S101 cannot be essential. In the latter case, when an event is detected, the artificial intelligence device 10 can provide a video list and provide a photo-toon service for the selected video. The video list can also include a broadcast program.

The processor 620 can extract image data of a predetermined unit (S105).

As described above, the predetermined unit can be any one of a frame, a scene, a sequence, etc. According to an embodiment, there can be multiple predetermined units in one video data, and at this time, each unit can be different from each other. For example, one can be a scene unit and the other can be a sequence unit.

According to another embodiment, the predetermined unit can represent, for example, a playback section arbitrarily set by a user.

According to another embodiment, the predetermined unit can represent, for example, a section in which an object selected by a user is output. At this time, the object can be a concept including a person, an object, etc. Meanwhile, when there are multiple people as objects in the video data, only one person can be selected, and only the scene, section, etc. in which the selected person appears can be included in the predetermined unit.

According to another embodiment, the predetermined unit can be determined based on, for example, a theme, an attribute, etc., rather than a physical object basis. For example, if the artificial intelligence device 10 is requested to provide a photo-toon service for a video containing scenes of cooking and other scenes from a user, the device can set cooking as a theme and provide it, and can extract only the cooking-related section from the playback section of the target video and use it for the photo-toon service, depending on the selection.

Meanwhile, the artificial intelligence device 10 extracts information for the photo-toon service as a predetermined unit from the requested video playback section, but the requested video playback section does not necessarily have to be a continuous playback section.

If multiple videos are selected together as target videos for the photo-toon service, the artificial intelligence device 10 can also generate one photo-toon service data based on a predetermined unit set in advance for each video. For example, if the theme of ‘cooking’ is set as a unit and multiple target videos for the photo-toon service are selected, the device can automatically generate one photo-toon service data by extracting the cooking-related section from each target video.

Meanwhile, the artificial intelligence device 10 can provide a list of currently playable videos regardless of the photo-toon service, and can also provide identification information on whether or not each video on the provided video list is eligible for the photo-toon service.

The processor 620 can extract speech data corresponding to the extracted predetermined unit of image data (S107).

The processor 620 can STT process the extracted corresponding speech data (S109).

The processor 620 can synthesize the speech data, i.e., text data, converted to the extracted image data so that they are in sync (S111).

The processor 620 can provide a photo-toon service based on a synthesized image (S113).

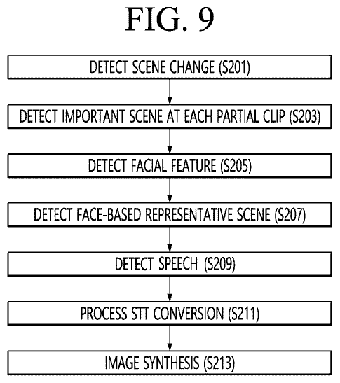

Next, referring to FIG. 9 and FIG. 12(a), a method for providing a photo-toon service based on a scene change will be described.

When a photo-toon service is requested for a video, the processor 620 can detect (or detect) a change in a predetermined unit within the video, for example, a scene change in FIG. 9 (S201).

Scene change detection can refer to either determining whether a scene change section exists within the target video or detecting data corresponding to the scene change section.

Referring to FIG. 12(a), a predetermined unit can be automatically set based on a scene change section.

Referring to FIG. 12(a), it can be seen that one scene starts at a first time point 1210 and another scene starts at a second time point 1220.

In FIG. 9 and FIG. 12(a), a scene change can be a section corresponding to a predetermined unit of FIG. 8 described above.

The processor 620 can detect a main scene (or important scene) for each partial clip (S203).

The processor 620 can detect facial features in the main scene of each detected partial clip (S205).

The processor 620 can detect a representative scene based on the facial features of the main scenes of each partial clip detected in step S205 (S207).

The processor 620 can extract speech data of a section corresponding to the representative scene detected in step S207 (S209).

The processor 620 can STT convert and process the speech data extracted in step S209 (S211).

The processor 620 can synthesize the representative scene detected in step S207 and the data processed by STT in step S211 (S213).

The processor 620 can provide a photo-toon service by using the synthesized data, i.e., the photo-toon synthesis date.

The photo-toon service provision method is based on preset conditions, but can be arbitrarily changed.

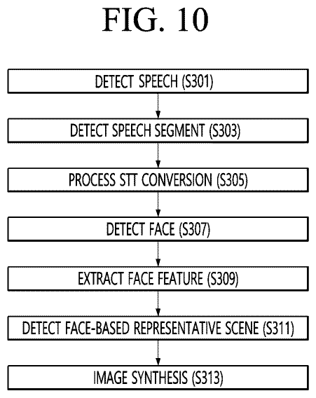

Next, referring to FIGS. 10 and 12(b), a description will be given of providing a photo-toon service based on a speech output section.

The processor 620 can detect speech in a video playback section (S301).

If speech is detected in the video playback section through step S301, the processor 620 can extract the section where the speech is detected, i.e., the speech section (S303).

The above-described step S301 can be omitted and integrated into step S303.

Meanwhile, referring to FIG. 12(b), a predetermined unit can be automatically set based on speech section extraction.

Referring to FIG. 12(b), speech can be output at a third time point 1230 and output again at a fourth time point 1240. Therefore, only the scene at the time point where the speech is output can be extracted.

If the processor 620 extracts a speech section in step S303, it can STT convert and process the speech data of the corresponding section (S305).

The processor 620 can detect face data on the frame of the section from which the speech data was extracted in step S303 (S307).

The processor 620 can extract face features from the face data detected in step S307 (S309).

The processor 620 can detect a representative scene based on the face features extracted in step S309 (S311).

The processor 620 can synthesize the data subjected to STT conversion in step S305 and the representative scene detected in step S311 into a single image (S313).

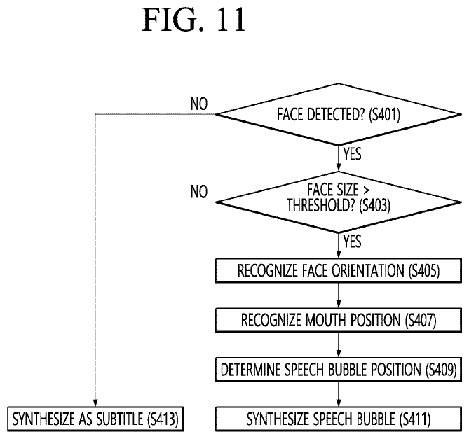

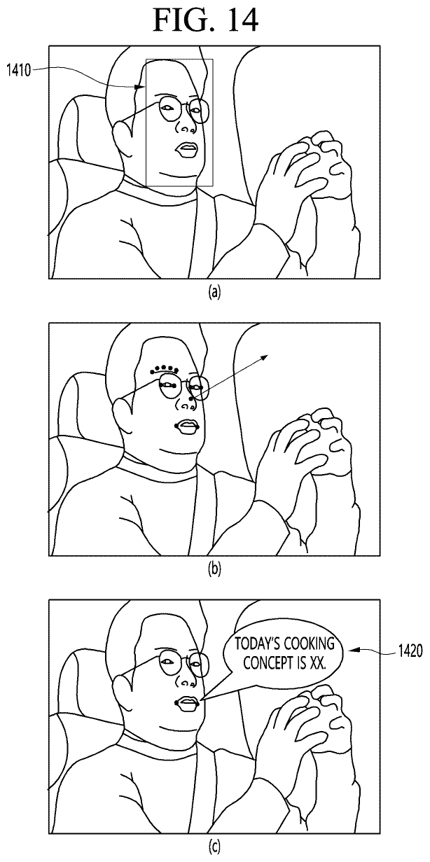

In FIG. 11 and FIG. 14, for example, a method of synthesizing an image is described when providing a photo-toon service.

Referring to FIG. 11 and FIG. 14, when synthesizing an image, the processor 620 can determine whether a face 1410 is detected, as shown in FIG. 14(a) (S401).

If a face is detected as a result of the determination in step S401, the processor 620 can determine whether the face size exceeds a threshold value (S403).

If the processor 620 determines that the face size exceeds the threshold value as a result of the determination in step S403, the processor 620 can recognize the face direction as shown in FIG. 14(b) (S405).

If the face direction is recognized in step S405, the processor 620 can then recognize the mouth position as illustrated in FIG. 14(c)v(S407).

The processor 620 can determine the position where the STT converted text information is output based on the face direction recognized in step S405 and the mouth position recognized in step S407, i.e., the position of the speech bubble 1430 (S409).

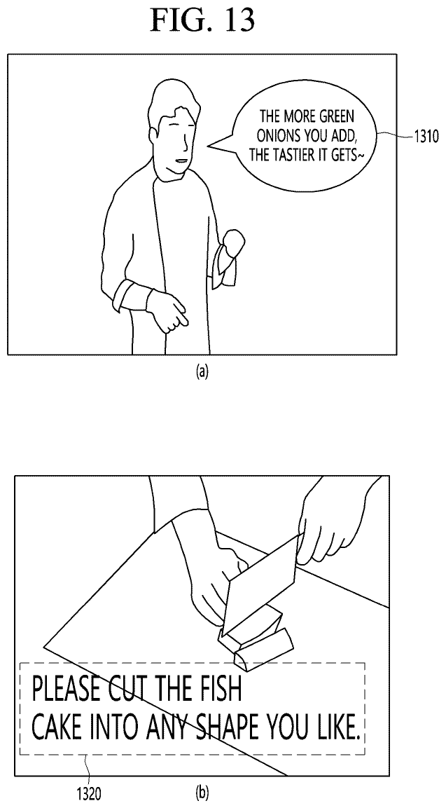

If the speech bubble position is determined through step S409, the processor 620 can synthesize the speech bubble data and the image frame into one image so that the speech bubble 1310, 1430 is output at the corresponding position as illustrated in FIG. 13(a) and FIG. 14(c) (S411).

Meanwhile, if the processor 620 determines that a face is not detected in the scene (or frame) at step S401 or that the face size is less than the threshold value at step S403, it can synthesize the scene or frame with the corresponding image so that it is output as a subtitle in a predetermined area 1320 within the image as shown in FIG. 13(b) (S413).

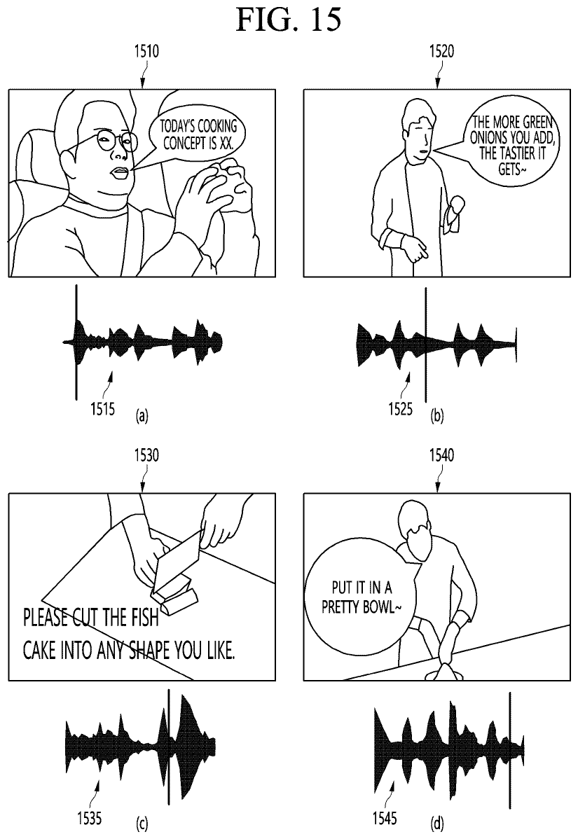

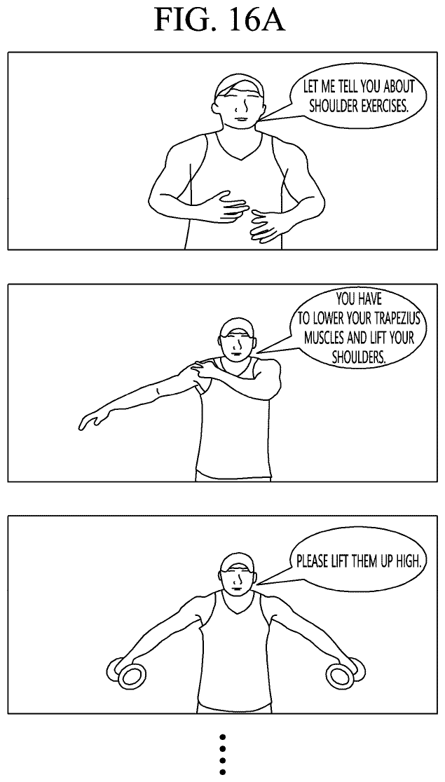

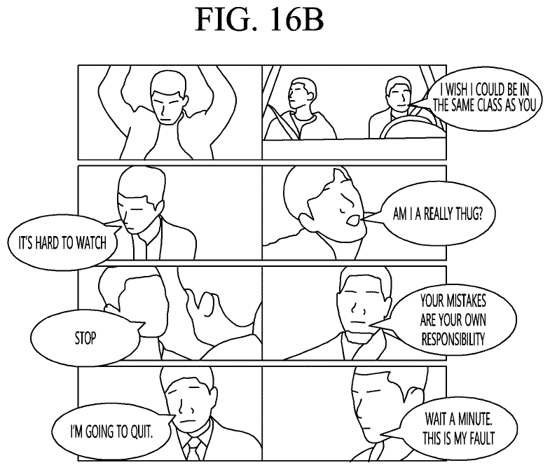

FIGS. 15, 16(a), and 16(b) are drawings illustrating a method for providing a photo-toon service using speech recognition technology according to an embodiment of the present disclosure.

FIG. 15(a) to 15(d) are drawings illustrating a method for summarizing video data using a photo-toon service, for example.

Here, the term “summarization” can mean providing only the main synthesized image among the synthesized images in which text information and corresponding image data that are subject to speech recognition are synthesized into one image based on one video data criterion or a predetermined unit criterion that is the target of the photo-toon service within one video data.

For convenience, FIG. 15(a) to 15(d) are described as being provided simultaneously through the output unit 150 of the artificial intelligence device 10.

According to the embodiment, FIG. 15(a) to 15(d) can each represent a synthesized image after speech data is converted to STT for each representative scene image in a single video. At this time, a speech waveform can be output at the bottom of each representative scene image, thereby providing location information of the current speech output.

When a synthesized image 1510 to 1540 is selected in FIG. 15(a) to 15(d), the artificial intelligence device 10 can provide the synthesized images of the scene associated with (or mapped to) the synthesized image in a slide format or can play a video (only the synthesized images in the form of a video) in the corresponding area.

Meanwhile, when a speech waveform 1515 to 1545 is selected in FIG. 15(a) to 15(d), the AI device 10 outputs a synthetic image corresponding to the corresponding speech position, and, depending on the selection, the synthetic images existing after the corresponding position can be sequentially played or provided.

In a similar manner, when a speech waveform 1515 to 1545 is dragged and dropped in an image area 1510 to 1540 in FIG. 15(a) to 15(d), the synthetic images of the scene related to the corresponding synthetic image can be sequentially played and provided.

In the screens of FIG. 15(a) to 15(d), the AI device 10 can simultaneously play at least two or more synthetic images (for example, as in FIGS. 15(a) and 15(c) ) depending on the user's selection. At this time, since text information is provided to the synthetic image itself, speech data can be muted.

According to another embodiment, the artificial intelligence device 10 can guide or provide control to change the playback speed or size of the synthetic image when at least one image 1510 to 1540 or speech waveform is long-clicked.

Referring to FIG. 16(a), when a user requests a photo-toon service for a target video, for example, video data related to fitness, the artificial intelligence device 10 can divide the entire video section into a plurality of synthetic image groups 1610, 1620, 1630 (for example, upper body fitness, lower body fitness, etc.) according to a fitness routine, and generate a synthetic image for each group.

If the user requests a photo-toon summary service separately, the AI device 10 can provide group-based synthetic images as shown in FIG. 16(a) to provide summary data of a fitness video.

Referring to FIG. 16(b), the AI device 10 can also provide a summary service for a drama or a movie according to the photo-toon service requested by the user. For example, in the case of a series drama, the AI device 10 extracts a synthetic image candidate image based on an actor such as the main character in each series or according to scene properties (e.g., action scene, drive scene, love scene) according to the user's photo-toon service request, and after extracting and STT processing the corresponding speech data, one image (synthetic image candidate image+speech bubble (converted text) ) is synthesized and played sequentially according to the playback order or provided in a slide format and provided sequentially.

In the present disclosure, the photo-toon summary service can be provided according to a request for providing a photo-toon service or according to a separate photo-toon summary request.

In the above, the group can be defined differently depending on the category, attribute, etc.

In FIGS. 13 to 16, when a specific object is selected in a synthesized image, the AI device 10 can operate as follows.

The AI device 10 can provide a list of information or other synthesized images related to the object.

The AI device 10 can re-perform a synthesized processing process for a photo-toon service for the target video data based on the object and provide the synthesized image.

For example, suppose that the AI device 10 performs a synthesized processing process for a photo-toon service for the main character, user A, in the target video and provides a synthesized image. At this time, the supporting character, user B, is output together with the provided synthesized image, and when the user selects the supporting character, user B, the AI device 10 can collect and output only the synthesized image for user B among the synthesized images or re-perform a synthesized processing process for a photo-toon service based on user B in the target video and provide the synthesized image.

The photo-toon service according to the present disclosure can perform a synthesis process only for the section where the face is exposed by dividing the target video into a section where the face is exposed and a section where the face is not exposed.

Alternatively, the photo-toon service according to the present disclosure can perform a synthesis process for each section, and can compose and output a summary photo-toon for each section.

In the photo-toon service according to the present disclosure, a synthesis image is generated by synthesizing a still image and text data, and at this time, the still image and text data can be data for a section where the synchronization is correct. However, according to another embodiment, in the case of content where it is relatively important for a person to be exposed, that is, a video, the synthesis image of the photo-toon service can be synthesized based on an image where the person is exposed, but the speech data of an image (scene) where only speech is output even if the person is not exposed can be synthesized together with the image where the person appears after STT conversion to generate a synthesis image.

The amount of the synthesis image composing the photo-toon service can be determined to be proportional to the amount or playback time of the target video. For example, if the target video is a 10-minute video, assuming that the amount of synthetic images is 10, the amount of synthetic images can be 30 if the target video is 30 minutes long. However, even in this case, if the playback time of the target video is above a certain level, it can be limited to a predetermined maximum amount of synthetic images.

According to at least one of the various embodiments of the present disclosure described above, by synthesizing text conversion data based on speech recognition for video data and providing a photo-toon service, the usability of the system can be expanded and the user's satisfaction can be improved or maximized. However, the present disclosure is not limited thereto, and conversely, for data composed of still image data and text, the text can be converted into speech based on speech recognition to provide a photo-toon service in the same manner as video data. The principle thereof can be easily inferred by referring to the above-described embodiments.

The description related to the method, order, etc. illustrated in the present disclosure is not necessarily bound by the order illustrated in the drawings, and the order can be changed or performed simultaneously according to the embodiments of the present disclosure. In addition, not all operations or processes depicted in the drawings are necessarily essential, so some operations or processes can be omitted or added in some embodiments.

As described above, according to at least one embodiment of the various embodiments of the present disclosure, a photo-toon service can be provided for a desired portion of video data of a predetermined length, and multimedia functions can be provided in conjunction with various applications.

Even if not specifically mentioned, the order of at least some of the operations disclosed in the present disclosure can be performed simultaneously or in a different order from the order described above, or some can be omitted/added.

According to one embodiment of the present invention, the above-described method can be implemented as a code that can be read by a processor on a medium in which a program is recorded. Examples of the medium that can be read by a processor include a ROM, a RAM, a CD-ROM, a magnetic tape, a floppy disk, an optical data storage device, etc.

The artificial intelligence device described above is not limited to the configuration and method of the embodiments described above, and the embodiments can be configured by selectively combining all or part of each embodiment so that various modifications can be made.

### INDUSTRIAL APPLICABILITY

According to the artificial intelligence device and its operation method according to the present disclosure, a photo-toon service utilizing speech recognition technology is provided for a predetermined unit of data constituting video data of various lengths, so that information can be recognized simply and easily through video data summarized as a photo-toon, thereby maximizing user satisfaction, and therefore, there is industrial applicability.

1. A method for operating an artificial intelligence device, comprising:
detecting an event;
extracting at least one image data configuring of the video data according to the event;
extracting speech data corresponding to the image data and processing the speech data as STT;
synthesizing the STT-processed data and the image data into a single image; and
outputting the synthesized image.

2. The method according to claim 1, wherein the event includes receiving a photo-toon service request signal.

3. The method according to claim 2, wherein the at least one image data is data corresponding to one of a frame, a scene, and a sequence unit that is a set of multiple scenes.

4. The method according to claim 2, wherein the at least one image data is determined based on an object in the video data.

5. The method according to claim 1, further comprising:
detecting a face from the at least one image data;
recognizing a face direction when a size of the detected face exceeds a threshold value;
recognizing a mouth position of the face;
determining a position of a speech bubble including the STT-processed data according to the face direction and the mouth position of the face recognized for the detected face; and
synthesizing the speech bubble including the STT-processed data with the image data to be positioned at the determined position of the speech bubble.

6. The method according to claim 5, further comprising:
when a face is not detected from the at least one image data, determining a position of the speech bubble to be output to an area of the screen and synthesizing the speech bubble with the image data.

7. The method according to claim 1, wherein at least one image data corresponds to a scene change section in the video or a speech output section.

8. The method according to claim 1, wherein when the synthesized images are multiple for the video data, the multiple synthesized images are grouped and summarized according to predefined criteria, and only some of the synthesized images are output.

9. An artificial intelligence device, comprising:
a display configured to output video data; and
a processor configured to control the display,
wherein the processor is configured to detect an event, extract at least one image data configuring of the video data according to the event, extract speech data corresponding to the image data, process the speech data as STT, and synthesize the STT-processed data and the image data into a single image and output the synthesized image.

10. The artificial intelligence device according to claim 9, wherein the event includes receiving a photo-toon service request signal, and the at least one image data is data corresponding to one of a frame, a scene, and a sequence unit that is a set of multiple scenes.

11. The artificial intelligence device according to claim 10, wherein the processor is configured to determine the at least one image data based on an object in the video data.

12. The artificial intelligence device according to claim 9, wherein the processor is configured to detect a face from the at least one image data, recognize, when a size of the detected face exceeds a threshold value, a face direction and a mouth position of the face, determine a position of a speech bubble including the STT-processed data according to the face direction and the mouth position of the face recognized for the detected face, and synthesize the speech bubble including the STT-processed data with the image data to be positioned at the determined position of the speech bubble.

13. The artificial intelligence device according to claim 9, wherein when a face is not detected from the at least one image data, the processor is configured to determine a position of the speech bubble to be output to an area of the screen, and synthesize the speech bubble with the image data.

14. The artificial intelligence device according to claim 9, wherein at least one image data corresponds to a scene change section in the video or a speech output section.

15. The artificial intelligence device according to claim 9, wherein when the synthesized images are multiple for for the video data, the processor is configured to group and summarize the multiple synthesized images according to a predefined criterion for the video data, and output only some of the synthesized images.
